(19) United States
(12) Patent Application Publication
(10) Pub. No.: US 2025/0202847 A1
(43) Pub. Date: Jun. 19, 2025

(54) METHOD AND SYSTEM FOR MESSAGE OUTPUT ASSOCIATED WITH CHAT ROOM FREEZING IN INSTANT MESSAGING SERVICE

(71) Applicant: LINE PLUS CORPORATION, Gyeonggi-do (KR)

(72) Inventors: Heeyoung JEON, Seongnam-si (KR); Hyeonji JO, Seongnam-si (KR); Kyoung Jin KIM, Seongnam-si (KR); Eo Jin YANG, Seongnam-si (KR)

(73) Assignee: LINE PLUS CORPORATION, Seongnam-si (KR)

(21) Appl. No.: 19/065,223

(22) Filed: Feb. 27, 2025

Related U.S. Application Data
(63) Continuation of application No. PCT/KR2023/012599, filed on Aug. 24, 2023.

(30) Foreign Application Priority Data
Sep. 20, 2022 (KR) 10-2022-0118326

(51) Int. Cl. H04L 51/04; H04L 51/212; H04L 51/216

(52) U.S. Cl. CPC H04L 51/04; H04L 51/212; H04L 51/216

(57) ABSTRACT

A method for outputting a message associated with chat room freeze in an instant messaging service includes: receiving, from a user, a request to freeze a specified chat room, or the request to freeze the specified chat room and a request to set a frozen period corresponding to a period in which the specified chat room is in a frozen state; based on receiving the request to freeze the specified chat room, suspending a reception of one or more messages of the specified chat room from a server; and based on receiving, from the user, a request to unfreeze the specified chat room, or based on the specified chat room being in the frozen state for the period corresponding to the set frozen period, receiving the one or more messages from the server.

### CROSS-REFERENCE TO RELATED APPLICATIONS

The present application is a continuation of International Patent Application No. PCT/KR2023/012599, filed on Aug. 24, 2023, which is based upon and claims the benefit of priority to Korean Patent Application No. 10-2022-0118326, filed on Sep. 20, 2022. The disclosures of the above-listed applications are hereby incorporated by reference herein in their entireties.

### BACKGROUND

### 1. Field

The present disclosure relates to a method and a system for outputting a message associated with chat room freeze in an instant messaging service, and specifically, to a method and a system for blocking output of messages received in association with a specific chat room or notifications if freezing is set for the specific chat room of the instant messaging application, and outputting messages received during a frozen period or summary text if the chat room is unfrozen.

### 2. Description of the Related Art

With the proliferation of mobile devices such as smartphones and the development of the Internet, the use of instant messaging applications using mobile devices is becoming widespread. Users who use instant messaging applications through mobile devices may exchange various messages and content with other users through chat rooms.

In the instant messaging application, a user may participate in a plurality of chat rooms to exchange messages with other users. The user participating in the plurality of chat rooms may receive various messages simultaneously or within a short period of time, but the received messages may not always include important content that requires the user's immediate attention. For example, the user may be currently busy with work, etc., in which case he or she may need to check the messages received in the chat room associated with the current work more urgently than the relatively casual messages exchanged in a chat room with friends. In another example, if the user is on a vacation and there are messages received in the chat room associated with the work, the user may feel disturbed or even burdened by the need to check and read the received messages in the chat room.

Meanwhile, even if notifications for messages received in the specific chat room of the instant messaging application are turned off, part of the content of the latest new messages or the number of new messages for that chat room may still be output through a chat room list interface. In this case, the user is naturally drawn to checking the full messages of the chat room, making it difficult to focus on other important tasks that need to be addressed at the moment.

### SUMMARY

In order to solve one or more problems (e.g., the problems described above and/or other problems not explicitly described herein), provided is a method and a device (e.g., a system) for outputting a message associated with chat room freeze in an instant messaging service.

Additional aspects will be set forth in part in the description which follows and, in part, will be apparent from the description, or may be learned by practice of the presented embodiments.

According to an aspect of an embodiment, provided is a method for outputting a message associated with chat room freeze in an instant messaging service, the method may be performed by one or more processors of a user terminal and may include: receiving, from a user, a request to freeze a specified chat room, or the request to freeze the specified chat room and a request to set a frozen period corresponding to a period in which the specified chat room is in a frozen state; based on receiving the request to freeze the specified chat room, suspending a reception of one or more messages of the specified chat room from a server; and based on receiving, from the user, a request to unfreeze the specified chat room, or based on the specified chat room being in the frozen state for the period corresponding to the set frozen period, receiving the one or more messages from the server.

The method may further include, based on receiving the request to freeze the specified chat room, changing a display of a theme background of the specified chat room to a theme background corresponding to the frozen state, or changing, among a plurality of chat rooms in a chat room list interface of an instance messaging application, a display of the specified chat room to be different from a second chat room that is in an unfrozen state.

The method may further include, based on receiving the request to unfreeze the specified chat room or based on the specified chat room being in the frozen state for the period corresponding to the set frozen period, changing the display of the theme background of the specified chat room to a theme background corresponding to the unfrozen state.

The method may further include, based on receiving the request to freeze the specified chat room, changing, among a plurality of chat rooms in a chat room list interface of an instance messaging application, a display of the specified chat room to be different from a second chat room that is in an unfrozen state.

The method may further include, based on receiving the request to freeze the specified chat room, blocking a message input by the user in the specified chat room from being sent to the specified chat room.

Based on receiving the request to freeze the specified chat room, an output of the one or more messages to a display of the specified chat room may be suspended.

Based on receiving the request to freeze the specified chat room, an output of a notification indicating a reception of the one or more messages to a display of the specified chat room may be suspended.

The receiving the one or more messages from the server may include receiving a summary text of the one or more messages.

The summary text of the one or more messages may include one or more summary sentences generated by an artificial neural network-based model based on the one or more messages.

The summary text may be preferentially extracted from one or more messages that include a name of the user.

The summary text of the one or more messages may include one or more keywords generated by an artificial neural network-based model based on the one or more messages.

The method may further include, based on receiving the summary text of the one or more messages, outputting the summary text to a display of the user terminal.

The method may further include, based on receiving the one or more messages from the server, sequentially outputting the one or more messages to a display of the user terminal based on an order in which the one or more messages are generated.

The sequentially outputting the one or more messages to the display of the user terminal may include: receiving a first user input to control a message output frequency; and based on receiving the first user input, sequentially outputting the one or more messages to the display of the user terminal according to the message output frequency corresponding to the first user input.

The sequentially outputting the one or more messages to the display of the user terminal may include: receiving a second user input to suspend a message output; and based on receiving the second user input, suspending an output or removal of the one or more messages on the display of the user terminal.

The sequentially outputting the one or more messages to the display of the user terminal may further include: receiving a third user input to control the outputting of the one or more messages; and in response to receiving the third user input, sequentially outputting the one or more messages to the display of the user terminal.

The sequentially outputting the one or more messages to the display of the user terminal may include: receiving a fourth user input to rewind a message output; and based on receiving the fourth user input, sequentially removing, from the display of the user terminal, the one or more messages in an order opposite to the order in which the one or more messages are generated.

The method may further include outputting a number of unoutput messages from the one or more messages on the display of the user terminal.

According to an aspect of an embodiment, provided is a non-transitory computer-readable recording medium storing instructions for causing performance of a method on a computer, and the method may include: receiving, from a user, a request to freeze a specified chat room, or the request to freeze the specified chat room and a request to set a frozen period corresponding to a period in which the specified chat room is in a frozen state; based on receiving the request to freeze the specified chat room, suspending a reception of one or more messages of the specified chat room from a server; and based on receiving, from the user, a request to unfreeze the specified chat room, or based on the specified chat room being in the frozen state for the period corresponding to the set frozen period, receiving the one or more messages from the server.

According to an aspect of the disclosure, a user terminal may include: a communication module; a memory storing one or more computer-readable programs; a display; and one or more processors connected to the memory and configured to execute the one or more computer-readable programs to: receive a request to freeze a specified chat room from a user; based on receiving the request to freeze the specified chat room, or based on receiving the request to freeze the specified chat room and a request to set a frozen period corresponding to a period in which the specified chat room is in a frozen state, suspending reception of one or more messages of the specified chat room from a server; and based on receiving, from the user, a request to unfreeze the specified chat room, or based on the specified chat room being in the frozen state for the period corresponding to the set frozen period, receiving the one or more messages from the server.

The one or more processors may be further configured to execute the one or more computer-readable programs to: control the display to display a plurality of chat rooms including the specified chat room in a chat room list interface of an instance messaging application; and based on receiving the request to freeze the specified chat room, suspending reception of one or more messages of the specified chat room from a server, and changing a display of a the specified chat room to be different a second chat room that is in an unfrozen state.

According to various aspects of the present disclosure, by freezing the chat room in the instant messaging service according to the method described above and blocking the output of messages and/or the output of message reception notifications, the user may focus on his or her current work or vacation. In addition, messages received in the frozen chat room may be stored in a separate storage or server without being lost, and sequentially output on the display later if the chat room is unfrozen. Additionally, the user is able to freely control the output of messages by freezing and unfreezing the chat room, thereby having increased user convenience.

According to various aspects of the present disclosure, the user can choose whether to receive messages of a specific chat room according to their preferences or priorities by freezing the specific chat room. For example, if the user is on vacation, the user may freeze the chat room associated with the work so that they can separate work from vacation and fully enjoy the vacation. In another example, if the user is working on a high-priority task, the user may freeze the chat room associated with lower-priority tasks so that they can fully concentrate on the high-priority task.

According to various aspects of the present disclosure, by receiving a summary text of the message content of the unfrozen chat room, the user can grasp the overall flow and content of the conversation without having to check each of of the numerous messages received during the frozen period of the chat room. In addition, since the summary text may be preferentially extracted from the messages that include the user's name among the messages received in the chat room, the user is able to quickly check important conversation content.

According to various aspects of the present disclosure, by controlling the output of the messages associated with the unfrozen chat room, the user can conveniently check the content of the messages. In addition, the user can easily grasp the flow of conversations that took place in the frozen chat room. Accordingly, user convenience can be improved.

The effects of the present disclosure are not limited to the effects described above, and other effects not described herein can be clearly understood by those of ordinary skill in the art (referred to as “ordinary technician”) from the description of the claims.

### BRIEF DESCRIPTION OF DRAWINGS

The above and other objects, features and advantages of the present disclosure will become more apparent to those of ordinary skill in the art by describing in detail exemplary aspects thereof with reference to the accompanying drawings, in which:

FIG. 1 illustrates an example of freezing a chat room in an instant messaging service and outputting messages upon unfreezing the chat room according to an embodiment;

FIG. 2 is a schematic diagram illustrating a configuration in which an information processing system is communicatively connected to a plurality of user terminals to output a message associated with chat room freeze according to an embodiment;

FIG. 3 is a block diagram of an internal configuration of the user terminal and the information processing system according to an embodiment;

FIG. 4 is a block diagram illustrating an internal configuration of a processor according to an embodiment;

FIG. 5 is a flowchart provided to explain a method for outputting a message associated with chat room freeze according to an embodiment;

FIG. 6 is a diagram illustrating an example of freezing a chat room in an instant messaging application according to an embodiment;

FIG. 7 is a diagram illustrating an example of unfreezing a chat room in an instant messaging application and outputting a summary text associated with messages received in the chat room according to an embodiment;

FIG. 8 is a diagram illustrating an example in which a user controls message output in an unfrozen chat room according to an embodiment; and

FIG. 9 is a flowchart provided to explain an example of a method for outputting a message associated with chat room freeze in an instant messaging service according to an embodiment.

### DETAILED DESCRIPTION

Hereinafter, example details for the practice of the present disclosure will be described in detail with reference to the accompanying drawings. However, in the following description, detailed descriptions of well-known functions or configurations may be omitted.

In the accompanying drawings, the same or corresponding components are given the same reference numerals. In addition, in the following description of various examples, duplicate descriptions of the same or corresponding components may be omitted. However, even if descriptions of components are omitted, it is not intended that such components are not included in any example.

Advantages and features of the disclosed embodiments and methods of accomplishing the same will be apparent by referring to examples described below in connection with the accompanying drawings. However, the embodiments described herein are merely examples, and the present disclosure is not limited thereto, and may be implemented in various forms different from each other. The examples are merely provided to make the present disclosure complete, and to fully disclose the scope of the disclosure to those skilled in the art to which the present disclosure pertains.

The terms used herein will be briefly described prior to describing the disclosed example(s) in detail. The terms used herein have been selected as general terms which are widely used at present in consideration of the functions of the present disclosure, but these terms may be altered according to the intent of an operator skilled in the art, related practice, or introduction of new technology. In addition, in specific cases, certain terms may be arbitrarily selected by the applicant, and the meaning of the terms will be described in detail in a corresponding description of the example(s). Therefore, the terms used in the present disclosure should be defined based on the meaning of the terms and the overall content of the present disclosure rather than a simple name of each of the terms.

The singular forms “a,” “an,” and “the” as used herein are intended to include the plural forms as well, unless the context clearly indicates the singular forms. Further, the plural forms are intended to include the singular forms as well, unless the context clearly indicates the plural forms. Further, throughout the description, it will be understood that the terms “includes,” “comprises,” “has,” “having,” “including,” “comprising,” and the like specify the presence of stated features, figures, steps, operations, components, members, or combinations thereof, but do not preclude the presence or addition of one or more other features, figures, steps, operations, components, members, or combinations thereof. As used herein, each of the expressions “A or B,” “at least one of A and B,” “at least one of A or B,” “A, B, or C,” “at least one of A, B, and C,” and “at least one of A, B, or C,” may include one or all possible combinations of the items listed together with a corresponding expression among the expressions.

Further, the term “module” or “unit” as used herein refers to a software or hardware component, and the “module” or the “unit” performs certain roles. However, the meaning of the “module” or “unit” is not limited to software or hardware. The “module” or “unit” may be configured to be in an addressable storage medium or configured to execute one or more processors. Accordingly, as an example, the “module” or “unit” may include components such as software components, object-oriented software components, class components, and task components, and at least one of processes, functions, attributes, procedures, subroutines, program code segments, drivers, firmware, micro-codes, circuits, data, database, data structures, tables, arrays, or variables. Functions provided in the components and the “modules” or “units” may be combined into a smaller number of components and “modules” or “units”, or further divided into additional components and “modules” or “units.”

The “module” or “unit” may be implemented as a processor and a memory. The “processor” should be interpreted broadly to include at least one of a general-purpose processor, a central processing unit (CPU), a microprocessor, a digital signal processor (DSP), a controller, a microcontroller, a state machine, etc. Under some circumstances, the “processor” may include an application-specific integrated circuit (ASIC), a programmable logic device (PLD), a field-programmable gate array (FPGA), etc. The “processor” may include a combination of processing devices, e.g., a combination of a DSP and a microprocessor, a combination of a plurality of microprocessors, a combination of one or more microprocessors in conjunction with a DSP core, or any other combination of such configurations. In addition, the “memory” should be interpreted broadly to include any electronic component that is capable of storing electronic information. The “memory” may include any one or more of various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. The memory is said to be in electronic communication with a processor if the processor can read information from and/or write information to the memory. The memory integrated with the processor is in electronic communication with the processor.

In one or more embodiments of the present disclosure, a “system” may refer to at least one of a server apparatus and a cloud apparatus, but is not limited thereto. For example, the system may include one or more server apparatus. In an embodiment, the system may include one or more cloud apparatus. In an embodiment, the system may include both the server apparatus and the cloud apparatus operating in conjunction with each other.

In one or more embodiments of the present disclosure, a “display” may refer to any display device associated with a computing device. For example, the “display” may refer to any display device that is controlled by the computing device, or that can display any information/data provided from the computing device.

In one or more embodiments of the present disclosure, “each of a plurality of A's” may refer to each of all components included in the plurality of A's, or may refer to each of some of the components included in the plurality of A's.

In one or more embodiments of the present disclosure, a “chat room” may refer to a virtual space or group in which one or more users (or user accounts) may participate, which may be generated in an instant messaging application installed on a computing device. For example, one or more user accounts participating in or associated with a chat room may exchange various types of messages, files, etc. with each other. In addition, the chat room may support Voice over Internet Protocol (VOIP) call or VoIP group call functions, allowing voice calls and/or video calls to be performed between user accounts.

In one or more embodiments of the present disclosure, an “instant messaging application” may refer to any software or application platform that supports real-time or near real-time communication between users. For example, the “instant messaging application” may include IMessage, WhatsApp, Snapchat, Telegram, or the like, but is not limited thereto. In one or more embodiments of the present disclosure, the service provided by the “instant messaging application” may be referred to as an “instant messaging service.”

In one or more embodiments of the present disclosure, “freezing a chat room” may refer to blocking an output of a message or notifications indicating message reception in the chat room while preventing the loss of the received message. Therefore, upon unfreezing the chat room, the messages received while the chat room is in the frozen state may be replayed or output through the chat room interface. In addition, if the chat room is in the frozen state, the message reception notifications or the number of unread messages in the frozen chat room may not be displayed in the chat room list interface of the instant messaging application.

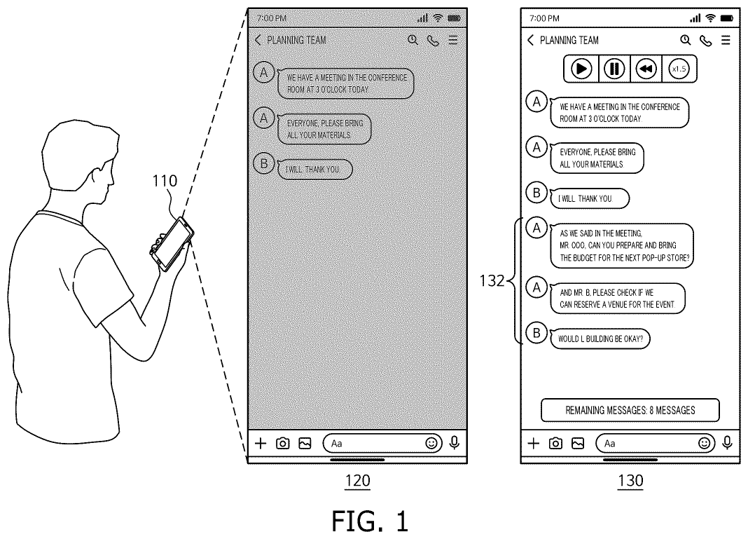

FIG. 1 illustrates an example of freezing a chat room in an instant messaging service and outputting messages upon unfreezing the chat room according to an embodiment. The user may use the instant messaging service through the instant messaging application in a user terminal 110. In addition, the user may exchange messages with other users in various types of chat rooms generated by the instant messaging application.

The user terminal 110 may display, on a display, a new message (or information associated with the new message) received in the chat room. For example, in response to receiving a new message, the user terminal may display on the display the new message by displaying in the chat room list interface the number of new messages and/or the content of the latest new message for the chat room that includes the new message. In an embodiment, the user terminal may display the new message in the form of a push notification notifying the reception of the new message or display the reception of the new message by displaying the number of new messages on an icon of the instant messaging application. In an embodiment, if the user enters the chat room that includes the new message or the user was already in the chat room before receiving the new message, the user terminal may display the content of the new message in the chat room. In response to receiving the new message, the user terminal 110 may sort the chat rooms on the chat room list interface according to the order the new messages are received in the chat rooms.

The user may freeze a specified chat room of the instant messaging application displayed on the display of the user terminal 110. A first operation 120 is an example illustrating a frozen chat room. If the chat room is frozen, output of new messages to the corresponding chat room may be suspended. In addition, output of a message reception notification indicating the reception of the new message may also be suspended. In this case, the new messages associated with the frozen chat room may be transmitted and stored in a separate storage or server to prevent loss. Additionally, a new message input to the frozen chat room by the user may be blocked or suspended.

A theme background of the frozen chat room may be changed to a theme background that indicates the chat room freezing. For example, the theme background of the frozen chat room may be changed to a gray tone indicating that the chat room is deactivated. In addition, an area of the frozen chat room in the chat room list interface of the instant messaging application may also be changed to gray tone to indicate the frozen or deactivated state of the chat room. In an embodiment, the display of the frozen chat room in the chat room list interface of the instant messaging application may be changed to a visually recognizable form. Through the changed theme background or changed display of the frozen chat room on the chat room list, the user may easily recognize that the chat room is frozen.

The user may unfreeze the chat room of the instant messaging application displayed on the display of the user terminal 110. A second operation 130 is an example illustrating the chat room after the chat room is unfrozen. For example, if the frozen chat room is unfrozen, the theme background of the chat room may be restored to the theme background previously set by the user. In an embodiment, the display of the frozen chat room on the chat room list may be changed to a recognizable form indicating that the chat room is unfrozen. In addition, messages 132 received while the chat room is frozen may be received from a server and sequentially output on the display of the user terminal 110. Additionally, the number of unoutput messages may be displayed on the display.

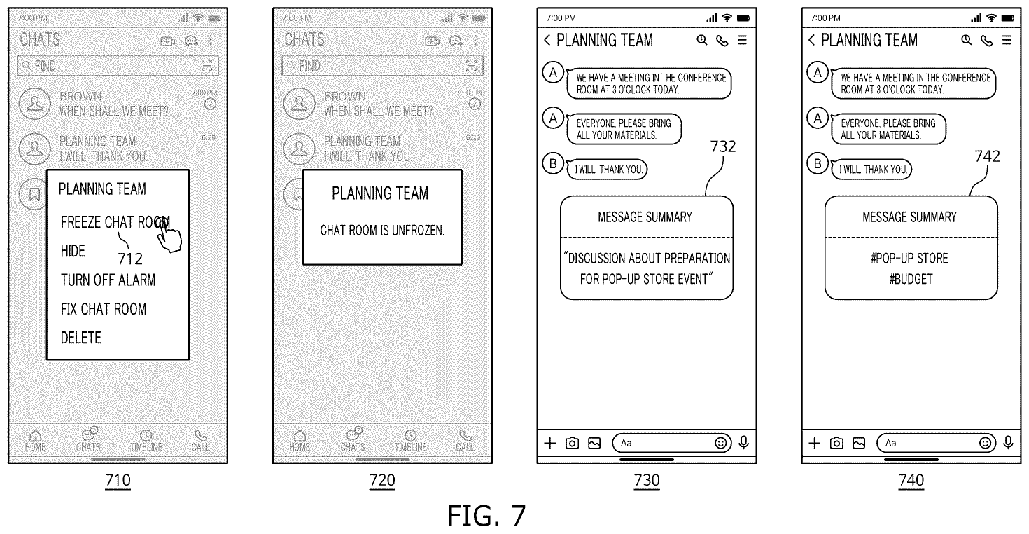

If the chat room is unfrozen, the user terminal 110 may receive summary text associated with the messages 132 transmitted from the server and output the received summary text on the display. The summary text may include one or more summary sentences generated by an artificial neural network-based model based on the messages 132 received in the frozen chat room. According to an embodiment, the summary text may include one or more keywords generated by the artificial neural network-based model based on the messages 132 received in the frozen chat room. An example of outputting the summary text will be described in detail below with reference to FIG. 7.

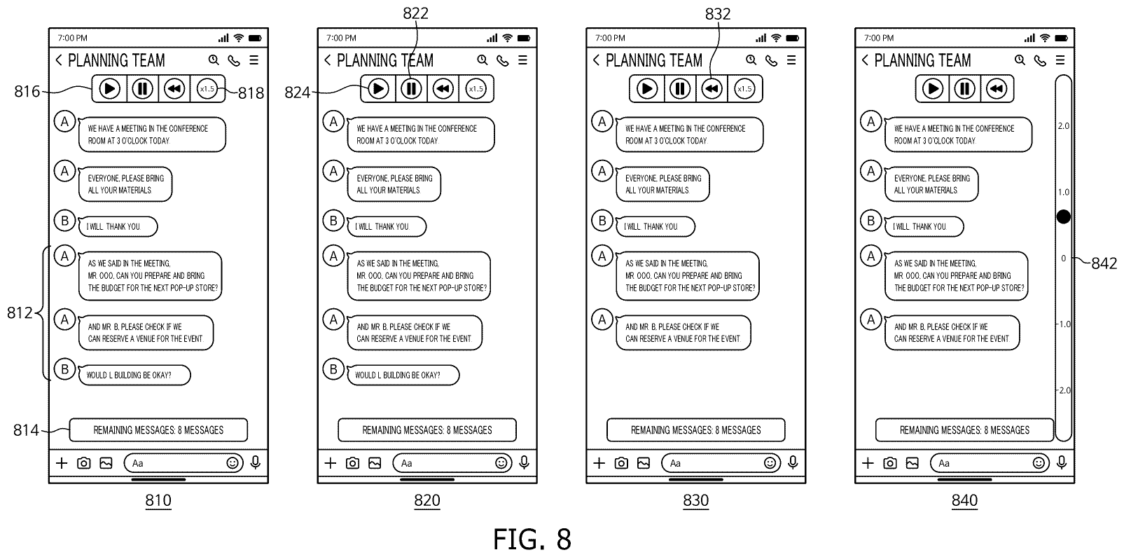

The user may control the method of outputting the messages 132 that are sequentially output on the display of the user terminal 110. In an embodiment, the user may select and execute functions such as starting message output, suspending message output, rewinding message output, adjusting message output speed, etc., using an output controller or menu displayed on an upper end of the chat room. An example in which the user controls the output of the messages 132 using the output controller will be described below in detail with reference to FIG. 8.

By freezing the chat room in the instant messaging service according to the method described above and blocking the output of messages and/or the output of message reception notifications, the user may focus on his or her current work or vacation. In addition, messages received in the frozen chat room may be stored in a separate storage or server to prevent loss, and sequentially output on the display later if the chat room is unfrozen. Additionally, the user is able to freely control the output of the messages by freezing and unfreezing the chat room, thereby having increased user convenience.

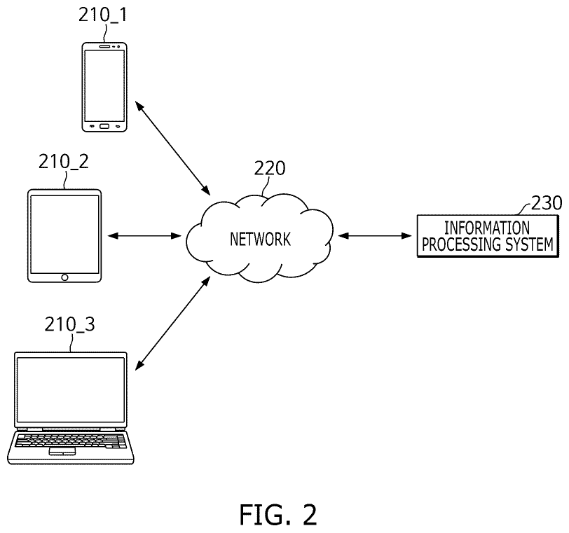

FIG. 2 is a schematic diagram illustrating a configuration in which an information processing system 230 is communicatively connected to a plurality of user terminals 210_1, 210_2, and 210_3 to output messages associated with chat room freeze according to an embodiment. As illustrated, the plurality of user terminals 210_1, 210_2, and 210_3 may be connected through a network 220 to the information processing system 230 that is capable of providing a service for outputting a message associated with chat room freeze. The plurality of user terminals 210_1, 210_2, and 210_3 may include a user's terminal provided with the service for outputting a message associated with chat room freeze.

The information processing system 230 may include one or more server devices and/or databases capable of storing, providing, and executing computer-executable programs (e.g., downloadable applications) and data associated with the service for providing a message associated with chat room freeze, or one or more distributed computing devices and/or distributed databases based on cloud computing services.

The service for outputting a message associated with chat room freeze provided by the information processing system 230 may be provided to the user through a message output service application web browser or a web browser extension program associated with chat room freeze installed in each of the plurality of user terminals 210_1, 210_2, and 210_3. For example, the information processing system 230 may provide information or perform a process corresponding to requests to freeze and unfreeze the chat room received from the user terminals 210_1, 210_2, and 210_3 through the message output service application, etc. associated with chat room freeze.

The plurality of user terminals 210_1, 210_2, and 210_3 may communicate with the information processing system 230 through the network 220. The network 220 may be configured to enable communication between the plurality of user terminals 210_1, 210_2, and 210_3 and the information processing system 230. The network 220 may be configured as a wired network such as Ethernet, a wired home network (Power Line Communication), a telephone line communication device and RS-serial communication, a wireless network such as a mobile communication network, a wireless LAN (WLAN), Wi-Fi, Bluetooth, and ZigBee, or a combination thereof, depending on the installation environment. The method of communication may include a communication method using a communication network (e.g., mobile communication network, wired Internet, wireless Internet, broadcasting network, satellite network, etc.) that may be included in the network 220 as well as short-range wireless communication between the user terminals 210_1, 210_2, and 210_3, but aspects are not limited thereto.

In FIG. 2, the mobile phone terminal 210_1, the tablet terminal 210_2, and the PC terminal 210_3 are illustrated as examples of the user terminal, but aspects are not limited thereto, and the user terminals 210_1, 210_2, and 210_3 may be any computing device that is capable of wired and/or wireless communication and capable of installing and executing the message output service application, the web browser, etc. associated with chat room freeze. For example, the user terminal may include an AI speaker, a smart phone, a mobile phone, a navigation, a computer, a notebook, a digital broadcasting terminal, a personal digital assistant (PDA), a portable multimedia player (PMP), a tablet PC, a game console, a wearable device, an internet of things (IoT) device, a virtual reality (VR) device, an augmented reality (AR) device, a set-top box, etc. In addition, FIG. 2 illustrates that three user terminals 210_1, 210_2, and 210_3 are in communication with the information processing system 230 through the network 220, but aspects are not limited thereto, and a different number of user terminals may be configured to be in communication with the information processing system 230 through the network 220.

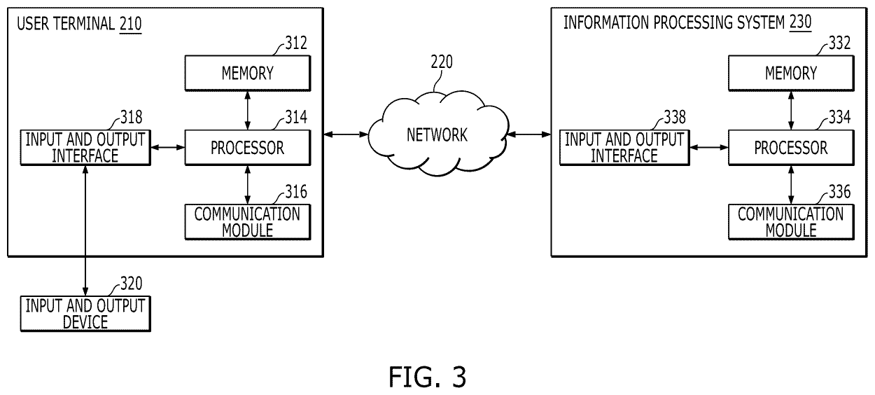

FIG. 3 is a block diagram of an internal configuration of the user terminal 210 and the information processing system 230 according to an embodiment. The user terminal 210 may refer to any computing apparatus that is capable of executing applications, web browsers, etc., and also capable of wired/wireless communication, and may include the mobile phone terminal 210_1, the tablet terminal 210_2, and the PC terminal 210_3 of FIG. 2, for example. As illustrated, the user terminal 210 may include at least one of a memory 312, a processor 314, a communication module 316, and an input/output interface 318. Likewise, the information processing system 230 may include at least one of a memory 332, a processor 334, a communication module 336, and an input/output interface 338. As illustrated in FIG. 3, the user terminal 210 and the information processing system 230 may be configured to communicate information, data, etc. through the network 220 using respective communication modules 316 and 336. In addition, an input/output device 320 may be configured to input information, data, etc. to the user terminal 210, or output information, data, etc. generated from the user terminal 210 through the input/output interface 318.

The memories 312 and 332 may include any non-transitory computer-readable recording medium. The memories 312 and 332 may include a permanent mass storage device such as read only memory (ROM), disk drive, solid state drive (SSD), flash memory, etc. In an embodiment, a non-destructive mass storage device such as ROM, SSD, flash memory, disk drive, etc. may be included in the user terminal 210 or the information processing system 230 as a separate permanent storage device that is distinct from the memory. In addition, an operating system and at least one program code may be stored in the memories 312 and 332.

These software components may be loaded from a computer-readable recording medium separate from the memories 312 and 332. Such a separate computer-readable recording medium may include a recording medium directly connectable to the user terminal 210 and the information processing system 230, and may include a computer-readable recording medium such as a floppy drive, a disk, a tape, a DVD/CD-ROM drive, a memory card, etc., for example. In an embodiment, the software components may be loaded into the memories 312 and 332 through the communication modules 316 and 336 rather than the computer-readable recording medium. For example, at least one program may be loaded into the memories 312 and 332 based on a computer program installed by files provided by developers or a file distribution system that distributes an installation file of an application through the network 220.

The processors 314 and 334 may be configured to process the instructions of the computer program by performing basic arithmetic, logic, and input/output operations. The instructions may be provided to the processors 314 and 334 from the memories 312 and 332 or the communication modules 316 and 336. For example, the processors 314 and 334 may be configured to execute the received instructions according to a program code stored in a recording device such as the memories 312 and 332.

The communication modules 316 and 336 may provide a configuration or function for the user terminal 210 and the information processing system 230 to communicate with each other through the network 220, and may provide a configuration or function for the user terminal 210, the information processing system 230, etc. to communicate with another user terminal or another system (e.g., a separate cloud system, etc.). For example, a request or data (e.g., a request to freeze a chat room, etc.) generated by the processor 314 of the user terminal 210 according to the program code stored in the recording device such as the memory 312 may be transmitted to the information processing system 230 through the network 220 under the control of the communication module 316. Conversely, a control signal or command provided under the control of the processor 334 of the information processing system 230 may be sent through the communication module 336 and the network 220 and received by the user terminal 210 through the communication module 316 of the user terminal 210. The communication modules 316 and 336 may also be referred to as communication interfaces, and may be implemented by any one or any combination of a digital modem, a radio frequency (RF) modem, an antenna circuit, a Wi-Fi chip, and related software and/or firmware.

The input/output interface 318 may be configured to interface with the input/output device 320. As an example, the input device may include a device such as a camera including an audio sensor and/or an image sensor, a keyboard, a microphone, a mouse, etc., and the output device may include a device such as a display, a speaker, a haptic feedback device, etc. In an embodiment, the input/output interface 318 may interface with a device such as a touch screen, etc. that incorporates a configuration or function for performing inputting and outputting. For example, when the processor 314 of the user terminal 210 processes the instructions of the computer program loaded into the memory 312, a service screen, etc., which is configured with the information, data, etc. provided by the information processing system 230 or another user terminals, may be displayed on the display through the input/output interface 318. While FIG. 3 illustrates that the input/output device 320 is not included in the user terminal 210, aspects are not limited thereto, and the input/output device may be configured as one device with the user terminal 210. In addition, the input/output interface 338 of the information processing system 230 may interface with a device for inputting or outputting that may be connected to or included in the information processing system 230. While FIG. 3 illustrates the input/output interfaces 318 and 338 as the components configured separately from the processors 314 and 334, aspects are not limited thereto, and the input/output interfaces 318 and 338 may be configured to be included in the processors 314 and 334.

The user terminal 210 and the information processing system 230 may include more components than those illustrated in FIG. 3. Some of the components of the related art may not necessarily require exact illustration. The user terminal 210 may be implemented to include at least a part of the input/output device 320 described above. In addition, the user terminal 210 may further include another component such as a transceiver, a global positioning system (GPS) module, a camera, various sensors, a database, etc. For example, if the user terminal 210 is a smartphone, it may include components generally included in the smartphone, and for example, it may be implemented such that various components such as an acceleration sensor, a gyro sensor, a microphone module, a camera module, various physical buttons, buttons using a touch panel, input/output ports, a vibrator for vibration, etc. are further included in the user terminal 210.

While the program for the message output service application, etc. associated with chat room freeze is operating, the processor 314 may receive text, image, video, voice and/or operation, etc. input or selected through an input device such as a touch screen, a keyboard, a camera including audio sensor and/or image sensor, microphone, etc. connected to the input/output interface 318, and may store the received text, image, video, voice, and/or operation, etc. in the memory 312 or provide the same to the information processing system 230 through the communication module 316 and the network 220.

The processor 314 of the user terminal 210 may be configured to manage, process and/or store the information, data, etc. received from the input/output device 320, another user terminal, the information processing system 230, a plurality of external systems, etc. The information, data, etc. processed by the processor 314 may be provided to the information processing system 230 through the communication module 316 and the network 220. The processor 314 of the user terminal 210 may send the information, data, etc. to the input/output device 320 through the input/output interface 318 to output the same. For example, the processor 314 may display the received information, data, etc. on a screen of the user terminal 210.

The processor 334 of the information processing system 230 may be configured to manage, process, and/or store information, data, etc. received from a plurality of user terminals 210, a plurality of external systems, etc. The information, data, etc. processed by the processor 334 may be provided to the user terminals 210 through the communication module 336 and the network 220.

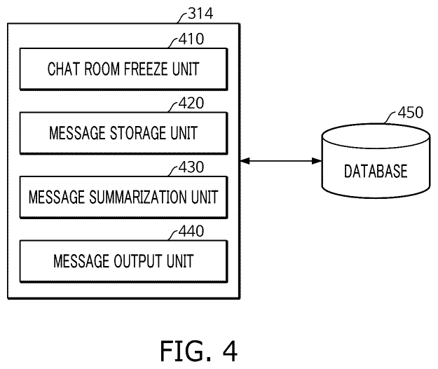

FIG. 4 is a block diagram illustrating an internal configuration of the processor 314 according to an embodiment. As illustrated, the processor 314 may include a chat room freeze unit 410, a message storage unit 420, a message summarization unit 430, and a message output unit 440.

The chat room freeze unit 410 may detect and receive a request to freeze a specific chat room from a user. In response to receiving the request to freeze the specific chat room from the user, the chat room freeze unit 410 may freeze the corresponding chat room to block output of messages to the chat room and output of message reception notifications in the chat room. In addition, the chat room freeze unit 410 may block message input to the frozen chat room by the user.

The chat room freeze unit 410 may change the theme background of the frozen chat room to a theme background that indicates the chat room freezing. For example, the chat room freeze unit 410 may change the theme background of the frozen chat room to a gray tone. In addition, the chat room freeze unit 410 may change the area of the frozen chat room in the chat room list interface of the instant messaging application to an area that indicates the chat room freezing.

The chat room freeze unit 410 may detect and receive a request to unfreeze a specific frozen chat room from the user. In response to receiving the request to unfreeze the specific frozen chat room, the chat room freeze unit 410 may change the theme background of the frozen chat room to an original theme back ground, which may be a theme background previously set by the user. In addition, if the chat room is unfrozen, the chat room freeze unit 410 may allow input of messages to the chat room by the user. In an embodiment, the chat room freeze unit 410 may change the display of the frozen chat room in the chat room list interface of the instant messaging application into a visually recognizable form. For example, among a list of a plurality of chat rooms in the chat room list interface, a frozen chat room may appear visually distinguishable from a chat room that is not frozen.

The chat room freeze unit 410 may freeze the chat room for a period set by the user. In addition, if the period of chat room freeze elapses, the chat room freeze unit 410 may unfreeze the chat room. Additionally, if the chat room is unfrozen, the chat room freeze unit 410 may output, on the display, a notification indicating that the chat room is unfrozen.

The message storage unit 420 may receive and store a message to prevent loss of the message in the frozen chat room. According to an embodiment, the message storage unit 420 may store the received message in a database 450. A plurality of received messages may be stored according to a time order in which the corresponding messages are received or generated. In addition, if the chat room is unfrozen, the message storage unit 420 may transmit the stored messages to the message summarization unit 430 and/or the message output unit 440.

The message summarization unit 430 may generate a summary text based on the received messages. The message summarization unit 430 may include an artificial neural network-based language model. For example, the message summarization unit 430 may use, as a language model, a transformer-based encoder-decoder or decoder model such as bidirectional encoder representations from transformers (BERT), a generative pre-trained transformer (GPT), bidirectional and automatic transformers (BART), etc., but aspects are not limited thereto. Additionally, if the chat room is unfrozen, the message summarization unit 430 may transmit the generated summary text to the message output unit 440.

The message summarization unit 430 may convert the messages received by the artificial neural network-based model into one or more summary sentences. For example, if the messages received in the frozen chat room are to schedule an appointment, the message summarization unit 430 may generate a summary sentence such as “discussion about appointment schedule” as the summary text. Additionally, the summary sentence may be preferentially extracted from the message including the user's name, because the message in which the user's name is mentioned is likely to be important to the user.

The message summarization unit 430 may convert the messages received by the artificial neural network-based model into one or more keywords. For example, if the messages received in the frozen chat room are to schedule an appointment, the message summarization unit 430 may generate a keyword such as “#appointment” as the summary text. Additionally, the keyword may be preferentially extracted from the message including the user's name, because since the message in which the user's name is mentioned is likely to be important to the user.

If a message mentioning the user who froze the chat room is received in the frozen chat room, the message output unit 440 may automatically output a message indicating that the mentioned user is not receiving outputs from the frozen chat room. For example, if another user in the frozen chat room mentions the user who froze the chat room using a mention function, etc., the message output unit 440 may output an automatic response message to the chat room, stating that the user who froze the chat room is currently not receiving outputs from the frozen chat room.

If the chat room is unfrozen, the message output unit 440 may sequentially output messages received from the message storage unit 420 to the chat room. In addition, the message output unit 440 may output the summary text received from the message summarization unit 430 to the chat room. Additionally, the message output unit 440 may display the number of unoutput messages in the chat room.

The message output unit 440 may control the message output in response to a user input associated with message output control. In response to receiving a user input associated with adjusting message output speed, the message output unit 440 may sequentially output messages to the chat room according to the message output speed corresponding to the user input. In an embodiment, in response to receiving a user input associated with suspending message output, the message output unit 440 may suspend outputting or removing messages in the chat room. In this case, the message output unit 440 may receive a user input associated with message output and output the messages to the chat room again. In an embodiment, in response to receiving a user input associated with rewinding message output, the message output unit 440 may sequentially remove the most recently output message from the chat room.

The internal configuration of the processor 314 illustrated in FIG. 4 is only an example, and in some examples, configurations other than the illustrated internal configuration may be additionally included, or some configurations may be omitted, or some processes may be performed by other configurations or external systems. For example, the message storage unit 420 or the message summarization unit 430 may be performed by the processor 334 of the information processing system 230. In addition, although the internal configurations of the processor 314 are described separately for each function in FIG. 4, the internal configurations may not be physically separated. For example, each block or unit may be physically separated into two or more interacting and discrete blocks or units without departing from the present scope. Further, the blocks or units may be physically combined into more complex blocks or units without departing from the present scope.

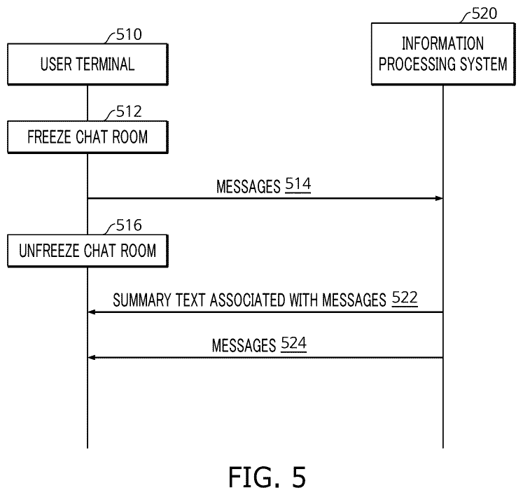

FIG. 5 is a flowchart provided to explain a method for outputting a message associated with chat room freeze according to an embodiment. A user terminal 510 may transmit and receive data to and from an information processing system 520. The information processing system 520 may be associated with an instant messaging service.

The user terminal 510 may receive a user input for freezing a specific chat room in the instant messaging application. In response to receiving the user input, the user terminal 510 may freeze the specific chat room, at S512. In this case, output of messages and output of message reception notifications in the chat room may be blocked. In addition, the theme background of the chat room may be changed to the theme background that indicates the chat room freezing. Additionally, the area of the chat room of the chat room list of the instant messaging application may be changed to an area that indicates the chat room freezing.

If the chat room is frozen, the user terminal 510 may transmit messages 514 received from the frozen chat room to the information processing system 520. The messages 514 received in the frozen chat room may be transmitted to the information processing system 520 according to time order in which the messages are received or generated. Accordingly, the information processing system 520 may store the received messages in chronological order.

The user terminal 510 may receive a user input for unfreezing the frozen chat room in the instant messaging application. In response to receiving the user input, the user terminal 510 may unfreeze the frozen chat room. In this case, the suspension of the output of the messages and the message reception notifications to the chat room may be lifted. In addition, the theme background of the chat room may be changed to an original theme background, which may include a theme background previously set by the user.

The user terminal 510 may receive a summary text associated with the messages received in the frozen chat room from the information processing system 520, at S522. The summary text may include one or more summary sentences generated by the artificial neural network-based model from the messages received in the frozen chat room. In an embodiment, the summary text may include one or more keywords generated by the artificial neural network-based model from the messages received in the frozen chat room. The user terminal 510 may output the received summary text on the display.

The user terminal 510 may receive, from the information processing system 520, messages received in the frozen chat room, at S524. In addition, the user terminal 510 may output the received messages on the display according to time order in which the messages are received. Additionally, the user terminal 510 may output the number of unoutput messages on the display.

The user terminal 510 may receive a user input for controlling the output of messages received while the chat room is in frozen state in the instant messaging application. In response to receiving the user input, the user terminal 510 may control the output of the messages. For example, in response to receiving a user input associated with adjusting message output speed, the user terminal 510 may sequentially output messages to the chat room according to the message output speed corresponding to the user input. In an embodiment, in response to receiving a user input associated with suspending the message output, the user terminal 510 may suspend outputting or removing the message in the chat room. In this case, the user terminal 510 may output the messages to the chat room again upon receiving a user input associated with the message output. In an embodiment, in response to receiving a user input associated with rewinding message output, the user terminal 510 may sequentially remove the most recently output message from the chat room.

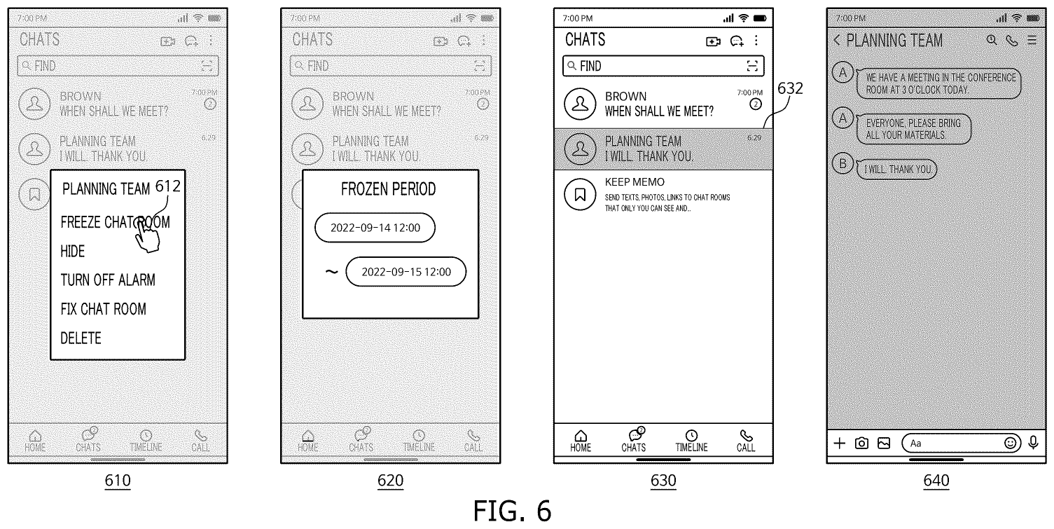

FIG. 6 is a diagram illustrating an example of freezing the chat room in the instant messaging application according to an embodiment. A first operation 610 is an example in which the user switches a “Planning Team” chat room of the instant messaging application to a frozen state. In the chat room list interface of the instant messaging application, the user may long-touch (or right-click) the area of a chat room they intend to freeze and enter chat room-related menus. In an embodiment, the user may enter the chat room-related menus within the chat room of the instant messaging application. Among the chat room-related menus, the user may select a chat room freeze 612 via touch input, etc. to freeze the corresponding chat room.

A second operation 620 is an example in which the user sets a period during which the “Planning Team” chat room is frozen. The user may set the period during which the “Planning Team” chat room is frozen by selecting, via touch input, etc., the start time for freezing the “Planning Team” chat room and the time for unfreezing the chat room. In an embodiment, if the period during which the chat room is frozen is not set, the “Planning Team” chat room may remain frozen until a request to unfreeze the chat room is received from the user.

A third operation 630 is an example in which an area 632 of the “Planning Team” chat room in the chat room list interface of the instant messaging application is changed as the chat room is frozen. In this case, the area 632 of the “Planning Team” chat room of the chat room list may be changed to a gray tone indicating that the chat room is frozen or deactivated. Accordingly, the user may easily identify the frozen chat room in the chat room list.

A fourth operation 640 is an example in which the theme background in the “Planning Team” chat room of the instant messaging application is changed as the chat room is frozen. In this case, the theme background of the “Planning Team” chat room may be changed to a gray tone indicating that the chat room is frozen or deactivated. Accordingly, the user may easily check that the “Planning Team” chat room is frozen.

As the “Planning Team” chat room is frozen, the output of messages received in the “Planning Team” chat room and the output of message reception notifications may be suspended. In this case, display of the number of new messages associated with the “Planning Team” chat room and the content of the latest new message on the chat room list interface may be suspended. In addition, the output of new messages in the “Planning Team” chat room may be suspended. In this case, the new messages in the “Planning Team” chat room may be transmitted and stored in a separate storage or server to prevent loss. Additionally, the message input by the user may be blocked in the “Planning Team” chat room.

If a message mentioning the user who froze the chat room is received in the frozen “Planning Team” chat room, a message indicating that the mentioned user is not in the frozen chat room may be automatically output to the frozen “Planning Team” chat room. For example, if another user using a mention function (for example, “@username”), etc. mentions the user who froze the chat room in the frozen “Planning Team” chat room, an automatic response message may be displayed in the chat room stating that the user who froze the chat room is currently not in the frozen chat room.

With such a configuration, the user may choose whether to receive messages of a specific chat room according to their preferences or priorities by freezing the specific chat room. For example, if the user is on vacation, the user may freeze the chat room associated with work so that they can separate work from vacation and fully enjoy the vacation. In another example, if the user is working on a high-priority task, the user may freeze the chat room associated with lower-priority tasks so that they may fully concentrate on the high-priority task.

FIG. 7 is a diagram illustrating an example of unfreezing the chat room in the instant messaging application and outputting a summary text associated with messages received in the chat room according to an embodiment. A first operation 710 is an example in which the user unfreezes the frozen state of the “Planning Team” chat room. In the chat room list interface of the instant messaging application, the user may long-touch (or right-click) the area of a chat room they intend to unfreeze and enter the chat room-related menus. In an embodiment, the user may enter the chat room-related menus within the chat room of the instant messaging application. Among the chat room-related menus, the user may select a chat room unfreeze 712 via touch input, etc. to unfreeze the frozen chat room. In an embodiment, if the user sets the frozen period for the “Planning Team” chat room, the “Planning Team” chat room may be automatically unfrozen when the period corresponding to the set frozen period elapses.

A second operation 720 is an example of outputting a notification when the “Planning Team” chat room is unfrozen. The notification of the “Planning Team” chat room being unfrozen may be popped up and outputted on the display. In an embodiment, the notification of the “Planning Team” chat room being unfrozen may be output on the upper end of the display in the form of a banner. A third operation 730 is an example in which a summary sentence 732 generated based on the messages received in the frozen state is output in response to unfreezing the frozen “Planning Team” chat room. One or more summary sentences 732 may be generated by the artificial neural network-based model based on the messages received in the chat room in the frozen state. For example, if a message received in the frozen “Planning Team” chat room is associated with preparing for a pop-up store event, the summary sentence 732 such as “Preparation for a pop-up store event discussed,” may be generated by the artificial neural network-based model. In this case, the summary sentence 732 may be preferentially extracted from a message including the user's name, because the message including the user's name is likely to be important to the user. Additionally, the generated summary sentence 732 may be popped up and output on the display.

A fourth operation 740 is an example in which a keyword 742 is output based on the messages received in the frozen state in response to unfreezing the frozen “Planning Team” chat room. One or more keywords 742 may be generated by the artificial neural network-based model based on the messages received in the chat room in the frozen state. For example, if a message received in the frozen “Planning Team” chat room is associated with preparing for a pop-up store event, the keyword 742 such as “#pop-up store,” “budget,” etc., may be generated by the artificial neural network-based model. In this case, the keyword 742 may be preferentially extracted from a message including the user's name, because the message in which the user's name is mentioned is likely to be important to the user. Additionally, the generated keyword 742 may be popped up and output on the display.

By receiving a summary text of the message content of the unfrozen chat room, the user may grasp the overall flow and content of the conversation without having to check each of the numerous messages received during the frozen period of the chat room. In addition, since the summary text may be preferentially extracted from the messages that include the user's name among the messages received in the chat room, the user is able to quickly check important conversation content.

FIG. 8 is a diagram illustrating an example in which a user controls message output in an unfrozen chat room according to an embodiment. If the frozen chat room is unfrozen, messages 812 received while the chat room is in the frozen state may be output on the display. In this case, the user may control the output of the messages as shown in a first operation 810, a second operation 820, and a third operation 830.

The first operation 810 is an example in which the messages 812 received in the frozen “Planning Team” chat room are output on the display in response to unfreezing the “Planning Team” chat room. The messages 812 received in the frozen “Planning Team” chat room may be sequentially output like new messages. The messages 812 may be output according to message output time interval (e.g., 3 seconds) designated by the user. In addition, the number 814 of unoutput messages may be output on the display.

An output controller 816 for controlling output messages may be displayed on the display. The user may adjust the message output speed by selecting, via touch input, etc., a message output speed control button 818 in the output controller 816. For example, the user may set a multiple (e.g., 1.5 times) of the current message output speed to adjust the message output speed. In an embodiment, the user may adjust the message output speed by setting the time interval (e.g., 2 seconds) at which the message is output.

The second operation 820 is an example in which the output of the messages is suspended in the unfrozen “Planning Team” chat room. In order to check the important message content included in the rapidly displayed messages, the user may select a message output suspend button 822 in the output controller via touch input, etc. to suspend the output of the messages. In this case, the output of the messages in the “Planning Team” chat room may be suspended. Additionally, in response to the user selecting a message output button 824 via touch input, etc. in the output controller, the message may be output again on the display.

The third operation 830 is an example in which the message output is rewound in the unfrozen “Planning Team” chat room. Rewinding the message output herein may refer to sequentially removing the most recently outputted message from the chat room. The user may rewind the output of the messages by selecting a message output rewind button 832 in the output controller via touch input, etc. For example, if the most recently output message in the “Planning Team” chat room is “Would the L Building okay?”, the message may be removed from the display in response to receiving a user input associated with message output rewind. In addition, the user may suspend rewinding the output of the messages by selecting the message output suspend button 822 via touch input, etc. in the output controller.

A fourth operation 840 is an example illustrating an output controller for controlling output messages according to some embodiments. The user may adjust the message output speed using a scrollbar 842. The user may select the message output speed by sliding the scrollbar 842 that represents a message output speed gauge. For example, if the user drags the scrollbar 842 down to the bottom of the display, the message output speed may slow down. Further, if the user drags the scrollbar 842 up to the top of the display, the message output speed may increase.

With such a configuration, by controlling the output of the messages associated with the unfrozen chat room, the user may conveniently check the content of the messages. In addition, the user may easily grasp the flow of conversations that took place in the frozen chat room. Accordingly, user convenience may be improved.

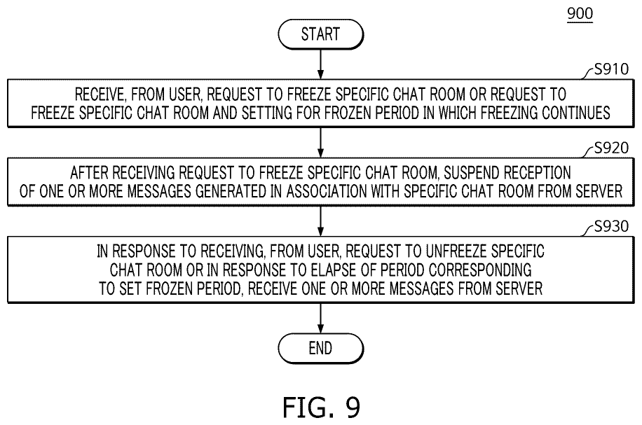

FIG. 9 is a flowchart provided to explain an example of a method 900 for outputting a message associated with chat room freeze in the instant messaging service according to an embodiment. The method 900 may be performed by one or more processors of the user terminal. The method 900 may be initiated by receiving, from a user, a request to freeze a specific chat room, or by receiving the request to freeze the specific chat room and setting of a frozen period during which freezing continues, at S910.

In response to receiving the request to freeze the specific chat room, the processor may change the theme background of the specific chat room to a theme background that indicates the chat room freezing, or change the display of the specific chat room to a visually recognizable form in the chat room list interface of the instant messaging application. In addition, in response to receiving the request to freeze the specific chat room, the processor may change the area of the specific chat room to an area that indicates the chat room freezing in the chat room list interface of the instant messaging application. Additionally, in response to receiving the request to freeze the specific chat room, the processor may block message input by the user in the specific chat room.

The reception of one or more messages generated in association with the specific chat room from the server may be suspended after the request to freeze the specific chat room is received, at S920. In this case, the output of the messages in the specific chat room may be suspended after the request to freeze the specific chat room is received. In addition, after the request to freeze the specific chat room is received, the output of a notification indicating the reception of the message in the specific chat room may be suspended.

In response to receiving, from the user, the request to unfreeze the specific chat room or in response to the elapse of a period corresponding to the set frozen period, one or more messages may be received from the server, at S930. In addition, in response to receiving a request to unfreeze the specific chat room or in response to the elapse of the period corresponding to the set frozen period, the processor may change the theme background of the specific chat room to a theme background previously set by a user.

The processor may receive a summary text associated with one or more messages. The summary text associated with the one or more messages may include one or more summary sentences generated by the artificial neural network-based model based on the one or more messages. For example, the summary text associated with the one or more messages may include one or more keywords generated by the artificial neural network-based model based on the one or more messages. Additionally, the summary text may be preferentially extracted from a message including the user's name.

In response to receiving one or more messages from the server, the processor may sequentially output the one or more messages on the display of the user terminal based on the order in which the one or more messages are generated. In this case, the processor may receive a first user input associated with adjusting the message output speed. In response to receiving the first user input, the processor may sequentially output one or more messages on the display of the user terminal according to a message output speed corresponding to the first user input. Additionally, the processor may output the number of unoutput messages from the one or more messages on the display of the user terminal.

The processor may receive a second user input associated with suspending the output of the messages. In response to receiving the second user input, the output or removal of the one or more messages on the display of the user terminal may be suspended. In this case, the processor may receive a third user input associated with outputting the messages. In response to receiving the third user input, the processor may sequentially output messages on the display of the user terminal.

The processor may receive a fourth user input associated with rewinding message output. In response to receiving the fourth user input, the processor may sequentially remove the most recently output message from the display of the user terminal.

The method described above may be provided as a computer program stored in a computer-readable recording medium for execution on a computer. The medium may be a type of medium that continuously stores a program executable by a computer, or temporarily stores the program for execution or download. In addition, the medium may be a variety of recording means or storage means having a single piece of hardware or a combination of several pieces of hardware, and is not limited to a medium that is directly connected to any computer system, and accordingly, may be present on a network in a distributed manner. An example of the medium includes a medium configured to store program instructions, including a magnetic medium such as a hard disk, a floppy disk, and a magnetic tape, an optical medium such as a CD-ROM and a DVD, a magneto-optical medium such as a floptical disk, a ROM, a RAM, a flash memory, etc. In addition, other examples of the medium may include an app store that distributes applications, a site that supplies or distributes various software, and a recording medium or a storage medium managed by a server.

The methods, operations, or techniques of the present disclosure may be implemented by various means. For example, these techniques may be implemented in hardware, firmware, software, or a combination thereof. Those skilled in the art will further appreciate that various illustrative logical blocks, modules, circuits, and algorithm steps described in connection with the disclosure herein may be implemented in electronic hardware, computer software, or combinations of both. To clearly illustrate this interchangeability of hardware and software, various illustrative components, blocks, modules, circuits, and steps have been described above generally in terms of their functionality. Whether such a function is implemented as hardware or software depends on design requirements imposed on the particular application and the overall system. Those skilled in the art may implement the described functions in varying ways for each particular application, but such implementation should not be interpreted as causing a departure from the scope of the present disclosure.

In a hardware implementation, processing units used to perform the techniques may be implemented in one or more ASICs, DSPs, digital signal processing devices (DSPDs), programmable logic devices (PLDs), field programmable gate arrays (FPGAs), processors, controllers, microcontrollers, microprocessors, electronic devices, other electronic units designed to perform the functions described in the present disclosure, computer, or a combination thereof.

Accordingly, various example logic blocks, modules, and circuits described in connection with the present disclosure may be implemented or performed with general purpose processors, DSPs, ASICs, FPGAs or other programmable logic devices, discrete gate or transistor logic, discrete hardware components, or any combination of those designed to perform the functions described herein. The general purpose processor may be a microprocessor, but in the alternative, the processor may be any related processor, controller, microcontroller, or state machine. The processor may also be implemented as a combination of computing devices, for example, a DSP and microprocessor, a plurality of microprocessors, one or more microprocessors associated with a DSP core, or any other combination of the configurations.

In the implementation using firmware and/or software, the techniques may be implemented with commands stored on a computer-readable medium, such as random access memory (RAM), read-only memory (ROM), non-volatile random access memory (NVRAM), programmable read-only memory (PROM), erasable programmable read-only memory (EPROM), electrically erasable PROM (EEPROM), flash memory, compact disc (CD), magnetic or optical data storage devices, etc. The commands may be executable by one or more processors, and may cause the processor(s) to perform certain aspects of the functions described in the present disclosure.

When implemented in software, the techniques may be stored on a computer-readable medium as one or more instructions or codes, or may be transmitted through a computer-readable medium. The computer-readable media include both the computer storage media and the communication media including any medium that facilitates the transmission of a computer program from one place to another. The storage media may also be any available media that may be accessible to a computer. By way of non-limiting example, such a computer-readable medium may include RAM, ROM, EEPROM, CD-ROM or other optical disk storage, magnetic disk storage or other magnetic storage devices, or any other media that can be used to transmit or store desired program code in the form of instructions or data structures and can be accessible to a computer. In addition, any connection is properly referred to as a computer-readable medium.

For example, if the software is sent from a website, server, or other remote sources using coaxial cable, fiber optic cable, twisted pair, digital subscriber line (DSL), or wireless technologies such as infrared, wireless, and microwave, the coaxial cable, the fiber optic cable, the twisted pair, the digital subscriber line, or the wireless technologies such as infrared, wireless, and microwave are included within the definition of the medium. The disks and the discs used herein include CDs, laser disks, optical disks, digital versatile discs (DVDs), floppy disks, and Blu-ray disks, where disks usually magnetically reproduce data, while discs optically reproduce data using a laser. The combinations described above should also be included within the scope of the computer-readable media.

The software module may reside in RAM memory, flash memory, ROM memory, EPROM memory, EEPROM memory, registers, hard disk, removable disk, CD-ROM, or any other form of storage medium known. An example storage medium may be connected to the processor such that the processor may read or write information from or to the storage medium. Alternatively, the storage medium may be integrated into the processor. The processor and the storage medium may be present in the ASIC. The ASIC may be present in the user terminal. Alternatively, the processor and storage medium may exist as separate components in the user terminal.

Although the examples described above have been described as utilizing aspects of the currently disclosed subject matter in one or more standalone computer systems, aspects are not limited thereto, and may be implemented in conjunction with any computing environment, such as a network or distributed computing environment. Furthermore, the aspects of the subject matter in the present disclosure may be implemented in multiple processing chips or devices, and storage may be similarly influenced across a plurality of devices. Such devices may include PCs, network servers, and portable apparatus.

The above-described embodiments are merely specific examples to describe technical content according to the embodiments of the disclosure and help the understanding of the embodiments of the disclosure, not intended to limit the scope of the embodiments of the disclosure. Accordingly, the scope of various embodiments of the disclosure should be interpreted as encompassing all modifications or variations derived based on the technical spirit of various embodiments of the disclosure in addition to the embodiments disclosed herein.

1. A method for outputting a message associated with chat room freeze in an instant messaging service, the method being performed by one or more processors of a user terminal and comprising:
receiving, from a user, a request to freeze a specified chat room, or the request to freeze the specified chat room and a request to set a frozen period corresponding to a period in which the specified chat room is in a frozen state;
based on receiving the request to freeze the specified chat room, suspending a reception of one or more messages of the specified chat room from a server; and
based on receiving, from the user, a request to unfreeze the specified chat room, or based on the specified chat room being in the frozen state for the period corresponding to the set frozen period, receiving the one or more messages from the server.

2. The method according to claim 1, further comprising, based on receiving the request to freeze the specified chat room, changing a display of a theme background of the specified chat room to a theme background corresponding to the frozen state, or changing, among a plurality of chat rooms in a chat room list interface of an instance messaging application, a display of the specified chat room to be different from a second chat room that is in an unfrozen state.

3. The method according to claim 2, further comprising, based on receiving the request to unfreeze the specified chat room or based on the specified chat room being in the frozen state for the period corresponding to the set frozen period, changing the display of the theme background of the specified chat room to a theme background corresponding to the unfrozen state.

4. The method according to claim 1, further comprising, based on receiving the request to freeze the specified chat room, changing, among a plurality of chat rooms in a chat room list interface of an instance messaging application, a display of the specified chat room to be different from a second chat room that is in an unfrozen state.

5. The method according to claim 1, further comprising, based on receiving the request to freeze the specified chat room, blocking a message input by the user in the specified chat room from being sent to the specified chat room.

6. The method according to claim 1, wherein, based on receiving the request to freeze the specified chat room, an output of the one or more messages to a display of the specified chat room is suspended.

7. The method according to claim 1, wherein, based on receiving the request to freeze the specified chat room, an output of a notification indicating a reception of the one or more messages to a display of the specified chat room is suspended.

8. The method according to claim 1, wherein the receiving the one or more messages from the server comprises receiving a summary text of the one or more messages.

9. The method according to claim 8, wherein the summary text of the one or more messages includes one or more summary sentences generated by an artificial neural network-based model based on the one or more messages.

10. The method according to claim 8, wherein the summary text is preferentially extracted from one or more messages that include a name of the user.

11. The method according to claim 8, wherein the summary text of the one or more messages includes one or more keywords generated by an artificial neural network-based model based on the one or more messages.

12. The method according to claim 8, further comprising based on receiving the summary text of the one or more messages, outputting the summary text to a display of the user terminal.

13. The method according to claim 1, further comprising, based on receiving the one or more messages from the server, sequentially outputting the one or more messages to a display of the user terminal based on an order in which the one or more messages are generated.

14. The method according to claim 13, wherein the sequentially outputting the one or more messages to the display of the user terminal comprises:
receiving a first user input to control a message output frequency; and
based on receiving the first user input, sequentially outputting the one or more messages to the display of the user terminal according to the message output frequency corresponding to the first user input.

15. The method according to claim 13, wherein the sequentially outputting the one or more messages to the display of the user terminal comprises:
receiving a second user input to suspend a message output; and
based on receiving the second user input, suspending an output or removal of the one or more messages on the display of the user terminal.

16. The method according to claim 15, wherein the sequentially outputting the one or more messages to the display of the user terminal further comprises:
receiving a third user input to control the outputting of the one or more messages; and
in response to receiving the third user input, sequentially outputting the one or more messages to the display of the user terminal.

17. The method according to claim 13, wherein the sequentially outputting the one or more messages to the display of the user terminal comprises:
receiving a fourth user input to rewind a message output; and
based on receiving the fourth user input, sequentially removing, from the display of the user terminal, the one or more messages in an order opposite to the order in which the one or more messages are generated.

18. (canceled)

19. A non-transitory computer-readable recording medium storing instructions for causing performance of the method according to claim 1 on a computer.

20. A user terminal, comprising:
a communication module;
a memory storing one or more computer-readable programs;
a display; and
one or more processors connected to the memory and configured to execute the one or more computer-readable programs to:
receive a request to freeze a specified chat room from a user;
based on receiving the request to freeze the specified chat room, or based on receiving the request to freeze the specified chat room and a request to set a frozen period corresponding to a period in which the specified chat room is in a frozen state, suspending reception of one or more messages of the specified chat room from a server; and
based on receiving, from the user, a request to unfreeze the specified chat room, or based on the specified chat room being in the frozen state for the period corresponding to the set frozen period, receiving the one or more messages from the server.

21. The user terminal according to claim 20, wherein the one or more processors are further configured to execute the one or more computer-readable programs to:
control the display to display a plurality of chat rooms including the specified chat room in a chat room list interface of an instance messaging application; and
based on receiving the request to freeze the specified chat room, suspending reception of one or more messages of the specified chat room from a server, and changing a display of a the specified chat room to be different a second chat room that is in an unfrozen state.
